(19) United States
(12) Patent Application Publication
(10) Pub. No.: US 2026/0225274 A1
(43) Pub. Date: Aug. 6, 2026

(54) RAZOR HANDLE

(71) Applicant: DORCO CO., LTD., Seoul (KR)

(72) Inventors: Sung Hee SON, Seoul (KR); Jun Soo CHANG, Seoul (KR); Jong Jin JEONG, Seoul (KR)

(21) Appl. No.: 19/400,261

(22) Filed: Nov. 25, 2025

Related U.S. Application Data
(63) Continuation of application No. PCT/KR2024/007104, filed on May 24, 2024.

(30) Foreign Application Priority Data
May 26, 2023 (KR) 10-2023-0068696
Jul. 21, 2023 (KR) 10-2023-0095160

(51) Int. Cl. B26B 21/52; B26B 21/22

(52) U.S. Cl. CPC B26B 21/521; B26B 21/225; B26B 21/522

(57) ABSTRACT

A razor handle is proposed. The razor handle may include a head part detachably coupled to the razor cartridge, and a grip part extending in the longitudinal direction from the head part. The razor handle may also include an actuation part provided in the head part and configured to operate the release of the razor cartridge when the head part and the razor cartridge are coupled. The upper surface of the actuation part may include a central portion, a first region sloping upward from the central portion toward the front, and a second region sloping upward from the central portion toward the rear. The upper surface of the actuation part may also include a third region sloping upward from the central portion toward one lateral side in a direction perpendicular to the longitudinal direction, and a fourth region sloping upward from the central portion toward the other lateral side in the transverse direction.

### CROSS-REFERENCE TO RELATED APPLICATIONS

This is a continuation application of International Patent Application No. PCT/KR2024/007104 filed on May 24, 2024, which claims priority to Korean patent application No. 10-2023-0068696 filed on May 26, 2023 and Korean patent application No. 10-2023-0095160 filed on Jul. 21, 2023, contents of each of which are incorporated herein by reference in their entireties.

### TECHNICAL FIELD

The present disclosure relates to a razor handle, and more specifically, to a razor handle for razors equipped with replaceable razor cartridges.

### DESCRIPTION OF RELATED TECHNOLOGY

Generally, a razor is a product used for cutting body hair such as fine hair on the face or body and beard, consisting of a razor handle for gripping and a razor cartridge provided with at least one razor blade that comes into contact with the skin to perform shaving.

Such razors include system razors, where the razor cartridge is replaceable, and disposable razors, where the razor cartridge is not replaceable.

### SUMMARY

One aspect is a razor handle that includes an actuation part, allowing the user to easily remove the razor cartridge from the razor handle.

The aspects of the disclosure are not limited to those described herein, and other aspects not mentioned herein may become apparent to those skilled in the art from the following description.

According to the embodiments of the present disclosure, at least the following effects are achieved:
The user can easily remove the razor cartridge from the razor handle.
The force required for the user to operate the actuation part can be reduced.
The contact area between the user's fingers and the actuation part can be increased.
During the assembly process of the actuation part and the head part, the actuation part can be assembled to the head part in only one direction.

The effects of the present disclosure are not limited to the contents exemplified above, and various other effects are included within this specification.

### BRIEF DESCRIPTION OF THE DRAWINGS

FIG. 1 is a perspective view showing a razor assembly including a razor handle according to an embodiment of the present disclosure.

FIG. 2 is an exploded perspective view of the razor assembly including a razor handle according to an embodiment of the present disclosure.

FIG. 3 is an exploded perspective view of the razor handle according to an embodiment of the present disclosure.

FIG. 4 is an exploded perspective view of the head part and the actuation part according to an embodiment of the present disclosure.

FIG. 5 is a top view of the actuation part according to an embodiment of the present disclosure.

FIG. 6 is a cross-sectional view taken along line I-I′ indicated in FIG. 5.

FIG. 7 is a cross-sectional view taken along line II-II′ indicated in FIG. 5.

FIG. 8 is a bottom view of the actuation part according to an embodiment of the present disclosure.

FIG. 9 is a top view of the head part according to an embodiment of the present disclosure.

### DETAILED DESCRIPTION

In system razors, methods for removing the razor cartridge include directly pressing or pulling the razor cartridge by the user to actually move and remove the razor cartridge, or operating an actuation part included in the razor handle to remove the razor cartridge.

A conventional method of operating the actuation part is for the user to place their thumb on the upper surface of the actuation part and push the actuation part in one direction to remove the razor cartridge.

If the contact area between the user's thumb and the upper surface of the actuation part is small or if the upper surface of the actuation part is slippery, the frictional force generated between the user's thumb and the upper surface of the actuation part may be insufficient, making it difficult to remove the razor cartridge through the operation of the actuation part.

In particular, the upper surface of the conventional actuation part had a concentrated pressure area only at the front end, resulting in a somewhat reduced sense of adhesion between the user's thumb and the upper surface of the actuation part during operation.

The advantages and features of the present disclosure, and methods of achieving them, will become apparent with reference to the embodiments described below in detail in conjunction with the accompanying drawings. However, the present disclosure is not limited to the embodiments disclosed herein and may be embodied in various other forms. These embodiments are provided to make the disclosure of the present disclosure thorough and to fully convey the scope of the disclosure to those skilled in the art, and the present disclosure is defined only by the claims.

Furthermore, the embodiments described in this specification will be explained with reference to cross-sectional views and/or schematic diagrams, which are ideal exemplary illustrations of the disclosure. Thus, the shapes of the exemplary illustrations may be modified based on manufacturing techniques and/or tolerances. Additionally, each component shown in the figures may be exaggerated or reduced for convenience of explanation. Throughout the specification, like reference numerals refer to like elements.

Also, in describing the elements of the embodiments of the present disclosure, terms such as first, second, i), ii), a), b), etc., may be used. These terms are only used to distinguish one element from another and do not inherently specify the nature, order, or sequence of the elements. When a component is said to “include” or “comprise” another component, it means that other components are not excluded and can be included unless specifically stated otherwise.

In this specification, the lateral and transverse directions refer to the x-axis direction in the drawings, the forward direction refers to the positive y-axis direction, the backward direction refers to the negative y-axis direction, the upward direction refers to the positive z-axis direction, the downward direction refers to the negative z-axis direction, and the height direction refers to the z-axis direction.

Hereinafter, the present disclosure will be described with reference to the drawings for explaining the razor handle according to the embodiments of the present disclosure.

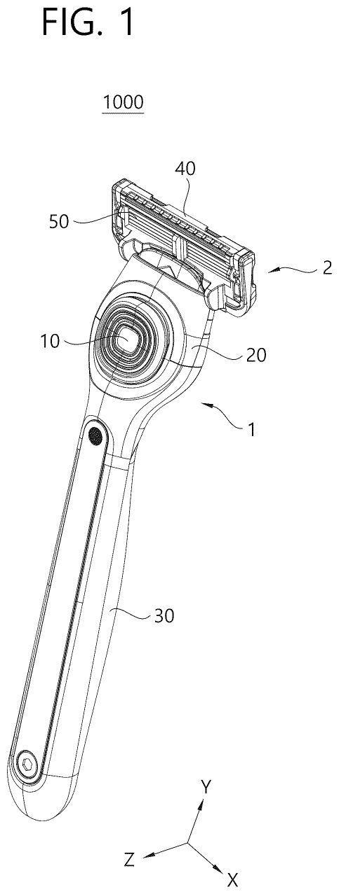

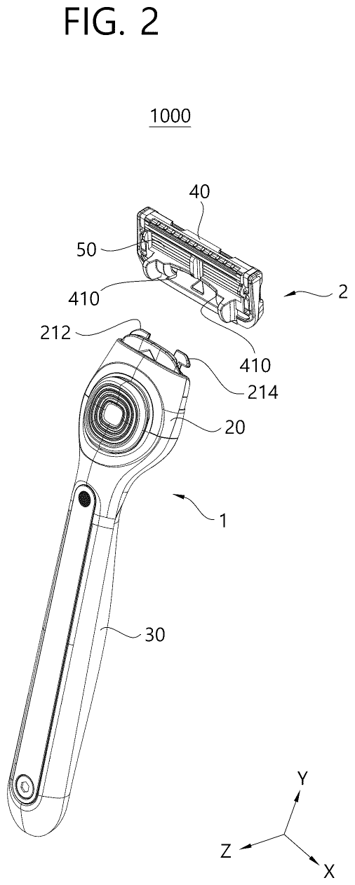

FIG. 1 is a perspective view showing a razor assembly including a razor handle according to an embodiment of the present disclosure, and FIG. 2 is an exploded perspective view of the razor assembly including a razor handle according to an embodiment of the present disclosure.

Referring to FIG. 1, the razor assembly 1000 according to an embodiment includes a razor handle 1 grasped by the user and a razor cartridge 2 detachably coupled to the razor handle 1.

The razor cartridge 2 can be detachably coupled to the razor handle 1.

The razor cartridge 2 may include a blade housing 40 and at least one blade 50, and the blade housing 40 may directly accommodate the blade 50.

A connector 410 may be formed on one side of the blade housing 40, which is detachably coupled to the razor handle 1.

Parts of the first arm 212 and the second arm 214 of the razor handle 1 are positioned inside the connector 410, allowing the razor handle 1 and the razor cartridge 2 to be coupled. The specific method of attaching and detaching the razor handle 1 and the razor cartridge 2 will be described later.

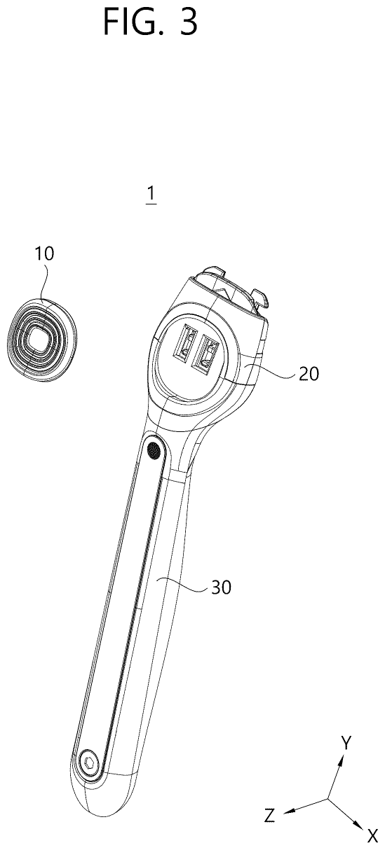

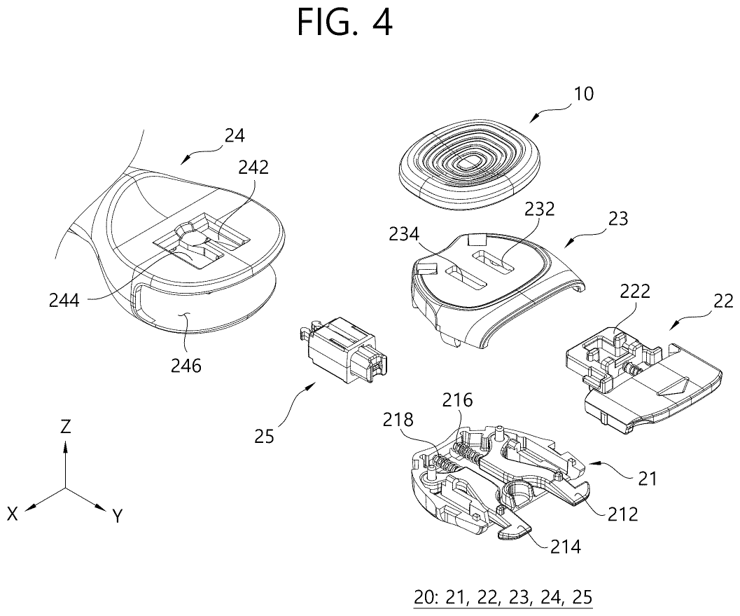

FIG. 3 is an exploded perspective view of the razor handle according to an embodiment of the present disclosure, and FIG. 4 is an exploded perspective view of the head part and the actuation part according to an embodiment of the present disclosure.

The razor handle 1 may include an actuation part 10, a head part 20, and a grip part 30.

The head part 20 is the portion of the razor handle 1 that is detachably coupled to the razor cartridge 2 and is positioned in the front region of the handle, while the grip part 30 extends rearward from the head part 20 and is grasped by the user. The head part 20 may extend at least partially in the longitudinal direction, the y-axis direction. The grip part 30 may be formed to extend rearward from the head part 20.

The actuation part 10 is a portion that the user operates to release the razor cartridge 2 from the razor handle 1 when the razor cartridge 2 is coupled to the razor handle 1 and may be positioned above the head part 20.

Referring to FIG. 4, the head part 20 may include a coupling part 21, a plunger 22, an upper housing 23, a head adapter 24, and a restoring force providing part 25.

The coupling part 21 is configured to directly couple with the razor cartridge 2 in the head part 20 and may include a first arm 212, a second arm 214, a first elastic member 216, and a second elastic member 218. The first elastic member 216 may be connected to the rear end of the first arm 212, and the second elastic member 218 may be connected to the rear end of the second arm 214.

Referring to FIG. 4, the first arm 212 and the second arm 214 may extend in the front-rear direction such that the transverse distance between them decreases towards the rear and then increases again. The first arm 212 and the second arm 214 may be symmetrically formed based on a virtual plane parallel to the yz plane.

Each of the first elastic member 216 and the second elastic member 218 can apply a restoring force to the rear when an external force is applied to the first arm 212 and the second arm 214, so as to restore them to their positions when no external force is applied. In an embodiment of the present disclosure, the first elastic member 216 and the second elastic member 218 each include a spring, but are not limited thereto.

The plunger 22 is a part that provides a restoring force to allow the razor cartridge 2 to rotate relative to the razor handle 1 by pressing the razor cartridge 2 forward and may be located above the coupling part 21 within the head part 20 in the height direction.

In an embodiment of the present disclosure, a pressing part 222 is arranged at the rear of the plunger 22. The pressing part 222 can move forward and press the first arm 212 and the second arm 214 such that the transverse distance between the front ends of the first arm 212 and the second arm 214 becomes narrower.

The pressing part 222 may be positioned outside the closest positions of the first arm 212 and the second arm 214 in the neutral position without any front-rear movement and may not press the first arm 212 and the second arm 214.

The pressing part 222 can move forward by the actuation part 10, and the specific method will be described later.

The upper housing 23 is positioned above the plunger 22 within the head part 20 in the height direction and can be coupled with the coupling part 21 in an up-down direction to accommodate the plunger 22 inside.

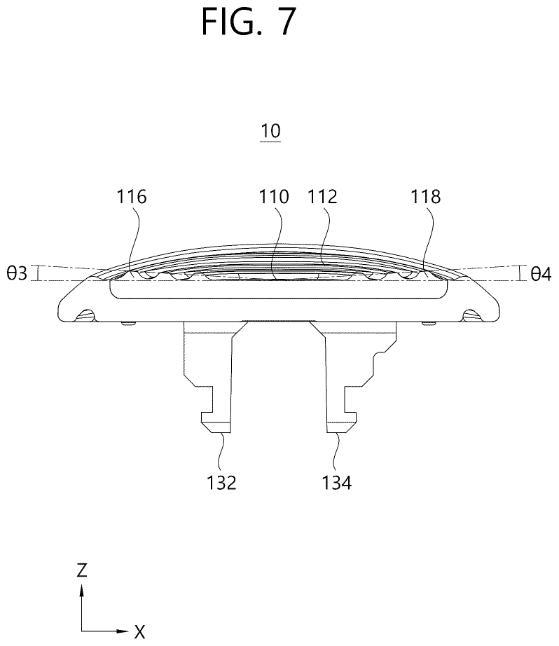

Additionally, the upper housing 23 may include a first hole 232 and a second hole 234 formed to penetrate in the height direction. A part of the actuation part 10, specifically the first protrusion 132 (see FIG. 7) and the second protrusion 134 formed on the lower part of the actuation part 10, may be inserted into the first hole 232 and the second hole 234, respectively.

In an embodiment of the present disclosure, the first hole 232 and the second hole 234 are each formed to extend in the longitudinal direction. The first hole 232 may have the same shape as the second hole 234, but is not necessarily limited thereto.

The head adapter 24 is configured to accommodate at least a part of the coupling part 21, the plunger 22, the pressing part 222 assembly, and the restoring force providing part 25.

The head adapter 24 may include a first accommodating part 242 and a second accommodating part 244 formed to penetrate in the height direction on the upper surface, and an internal space 246.

The internal space 246 can accommodate the assembly of the coupling part 21, the plunger 22, and the upper housing 23, which are stacked vertically. Additionally, the restoring force providing part 25 may be positioned at the rear of the internal space 246 and the assembly. The function of the restoring force providing part 25 will be described later.

A part of the actuation part 10, specifically the first protrusion 132 (see FIG. 7) and the second protrusion 134 formed on the lower part of the actuation part 10, may be inserted into the first accommodating part 242 and the second accommodating part 244, respectively.

In an embodiment of the present disclosure, the first accommodating part 242 and the second accommodating part 244 are each formed to extend in the longitudinal direction. The lengths of the first accommodating part 242 and the second accommodating part 244 in the longitudinal direction are formed longer than the lengths of the first protrusion 132 and the second protrusion 134, respectively, so that the actuation part 10 installed in the head part 20 can move forward or backward along the longitudinal direction. The shape and position of the first accommodating part 242 and the second accommodating part 244 are determined based on the shape and position of the first protrusion 132 inserted into the first accommodating part 242 and the second protrusion 134 inserted into the second accommodating part 244, so the shapes of the first accommodating part 242 and the second accommodating part 244 may differ.

That is, when the actuation part 10 is coupled to the head part 20, the first protrusion 132 (see FIG. 7) is inserted into the first hole 232 and the first accommodating part 242, and the second protrusion 134 is inserted into the second hole 234 and the second accommodating part 244.

When the actuation part 10 is coupled to the head part 20, the lower end of the first protrusion 132 (see FIG. 7) and the lower end of the second protrusion 134 can each be coupled to the pressing part 222.

Therefore, when the user operates the actuation part 10 forward, the pressing part 222 moves forward by the first protrusion 132 (see FIG. 7) and the second protrusion 134, and the forward-moving pressing part 222 can press the first arm 212 and the second arm 214 from the outside to the inside, causing the front ends of the first arm 212 and the second arm 214 to come closer together.

The restoring force providing part 25 is coupled to one side of the internal space 246 and provides a restoring force forward to the assembly of the coupling part 21, the plunger 22, and the upper housing 23.

The restoring force providing part 25 provides a forward restoring force to the assembly, allowing the assembly and the razor cartridge 2 to move backward together. Additionally, the restoring force provided by the restoring force providing part 25 allows the assembly and the razor cartridge 2 to perform a rotational movement about an axis parallel to the z-axis and a backward movement in the longitudinal direction.

As the backward movement and rotational movement of the razor cartridge 2 become possible due to the restoring force providing part 25, the degree of freedom of the razor cartridge 2 relative to the razor handle 1 increases, allowing the user to have a smoother shave.

In the razor handle 1 according to an embodiment of the present disclosure, the actuation part 10 can be moved forward to detach the razor cartridge 2 from the razor handle 1 by moving the pressing part 222 forward from the neutral position. Additionally, since the interior of the handle is not visible to the naked eye, the backward movement function of the cartridge by the assembly and the restoring force providing part needs to be tested. Therefore, it can be confirmed whether the assembly can move backward by moving the actuation part backward with a finger.

That is, the actuation part 10 can move forward and backward by the user's operation.

Meanwhile, the head part 20 may not include the head adapter 24 and the restoring force providing part 25. In this case, the head part 20 does not have the restoring force providing part 25, so the actuation part 10 may only move forward and not backward. Meanwhile, the operation distance of the actuation part 10 required for detaching the razor cartridge 2 from the razor handle 1 may be longer than the operation distance of the actuation part 10 required for the backward movement of the razor cartridge 2. Therefore, the possible forward movement distance of the actuation part 10 from the neutral position may be longer than the possible backward movement distance from the neutral position.

Specifically, the actuation part 10 according to an embodiment of the present disclosure can move forward by a distance of 1.5 mm to 3.5 mm from the neutral position and can move backward by a distance of 0.5 mm to 2.5 mm from the neutral position.

Referring to FIGS. 2 and 4, the process of attaching and detaching the razor handle 1 and the razor cartridge 2 is described.

When the user operates the actuation part 10 forward with the razor handle 1 and the razor cartridge 2 in a coupled state, the pressing part 222 moves forward. When the front ends of the first arm 212 and the second arm 214 are brought closer to each other in the transverse direction by the pressing part 222, at least one of the front ends of the first arm 212 and the second arm 214 is positioned to disengage from the connector 410, allowing the head part 20 and the connector 410 to be separated. That is, the razor handle 1 and the razor cartridge 2 can be separated from each other.

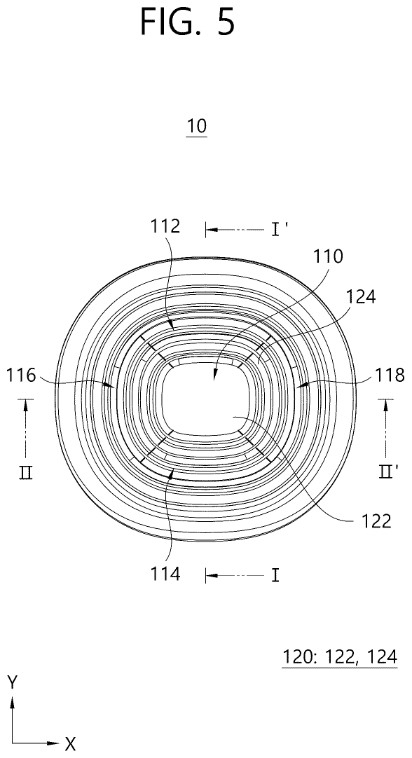

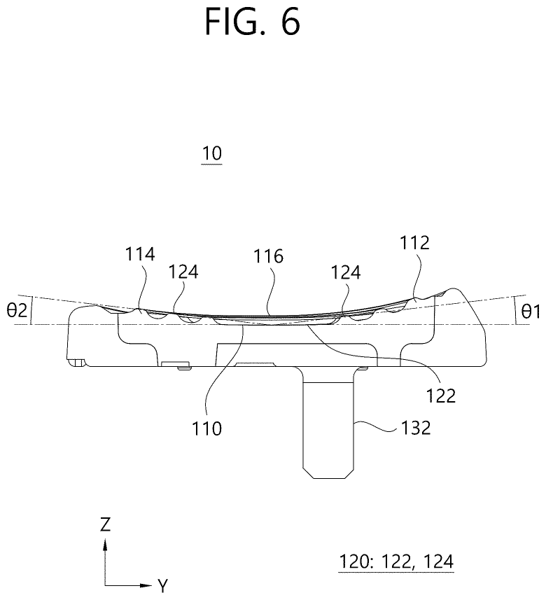

FIG. 5 is a top view of the actuation part according to an embodiment of the present disclosure. Additionally, FIG. 6 is a cross-sectional view taken along line I-I′ indicated in FIG. 5, and FIG. 7 is a cross-sectional view taken along line II-II′ indicated in FIG. 5.

The user operates the actuation part 10 by contacting the upper surface of the actuation part 10 with their finger, generally the thumb. As described above, the user can operate the actuation part 10 forward to release the razor cartridge 2 from the razor handle 1.

Specifically, referring to FIG. 5, the upper surface of the actuation part 10 may include a central portion 110, a first region 112, a second region 114, a third region 116, and a fourth region 118. Additionally, an elastic part 120 may be positioned on the upper surface of the actuation part 10.

Referring to FIGS. 5 and 6, the central portion 110 is located at the center of the upper surface of the actuation part 10 and may include a partially flat area. The flat area formed on the central portion 110 can increase the contact area between the upper surface of the actuation part 10 and the user's finger.

The first region 112 is located in front of the central portion 110 and may be formed to slope upward from the central portion 110 towards the front. The slope angle of the first region 112 is defined as the first slope angle (θ1).

The second region 114 is located behind the central portion 110 and may be formed to slope upward from the central portion 110 towards the rear. The slope angle of the second region 114 is defined as the second slope angle (θ2).

Referring to FIG. 6, in the actuation part 10 according to an embodiment of the present disclosure, the first slope angle (θ1) may be formed to be greater than or equal to the second slope angle (θ2), and preferably, the first slope angle (θ1) may be greater than the second slope angle (θ2).

The user's forward movement of the actuation part 10 is intended to detach the razor cartridge 2 from the razor handle 1, but the backward movement of the actuation part 10 can be performed by the user to test the backward movement function and/or backward movement of the razor cartridge 2 due to shaving pressure.

Therefore, the primary movement of the actuation part 10 by the user will be forward movement, so the force intentionally applied by the user to the first region 112 is greater than the force intentionally applied to the second region 114. Thus, the first slope angle (θ1) may be formed larger than the second slope angle (θ2) to effectively apply more force by the user. Additionally, due to the curvature of the thumb shape that contacts the upper surface of the actuation part 10, the thumb placed on the first region 112 has a larger curvature than that on the second region 114, so the first slope angle (θ1) may be formed larger than the second slope angle (θ2).

In this case, the first slope angle (θ1) can be greater than or equal to the second slope angle (θ2) while having the maximum slope angle that does not reduce the contact area when the user contacts the upper surface of the actuation part 10. In other words, if the first slope angle (θ1) has an excessively large slope, the contact area between the finger and the upper surface of the actuation part may be reduced, so the first slope angle (θ1) may not have an excessively large slope compared to the second slope angle (θ2). Specifically, the first slope angle (θ1) may have a value between 30 degrees and 65 degrees, and preferably between 40 degrees and 50 degrees. The second slope angle (θ2) may have a value between 10 degrees and 40 degrees, and preferably between 20 degrees and 40 degrees.

Meanwhile, the third region 116 is located towards one lateral side of the central portion 110 in the transverse direction perpendicular to the longitudinal direction and may be formed to slope upward from the central portion 110 towards one lateral side. The slope angle of the third region 116 is defined as the third slope angle (θ3).

The fourth region 118 is located towards the other lateral side of the central portion 110 in the transverse direction and may be formed to slope upward from the central portion 110 towards the other lateral side. The slope angle of the fourth region 118 is defined as the fourth slope angle (θ4).

The third slope angle (θ3) and the fourth slope angle (θ4) can be formed to increase the contact area when the user's finger contacts the upper surface of the actuation part.

Referring to FIG. 7, since the user intentionally moves the actuation part forward and backward, the third slope angle (θ3) and the fourth slope angle (θ4) may be formed to be the same to minimize unintended lateral movement of the actuation part by the user and to correspond to the user's finger curvature, which is symmetrical.

Meanwhile, because the user mainly operates the actuation part 10 forward and backward, the third slope angle (θ3) may be formed to be smaller than or equal to the second slope angle (θ2).

Additionally, in some embodiments, the third slope angle (θ3) and the fourth slope angle (θ4) of the actuation part 10 may be 0.

Meanwhile, in the actuation part 10 according to an embodiment of the present disclosure, the first region 112, the second region 114, the third region 116, and the fourth region 118 are all formed to slope upward from the central portion 110. Preferably, the boundary of the central portion 110 is located below the first region 112, the second region 114, the third region 116, and the fourth region 118.

That is, the upper surface of the actuation part 10 may be formed to be concave upward.

Therefore, when the user operates the actuation part 10, the user's finger, typically the thumb, is positioned on the upper surface of the actuation part 10, and if the upper surface of the actuation part 10 is formed to be concave to correspond to the curvature of the thumb, the user's finger can contact the central portion 110, the first region 112, the second region 114, the third region 116, and the fourth region 118. Thus, if the upper surface of the actuation part 10 is concavely formed, a larger area can contact the user's finger.

Since a larger area of the actuation part 10 contacts the user's finger, the user can operate the actuation part 10 with less pressure and can more easily remove the razor cartridge 2 from the razor handle 1.

Additionally, since the finger contacts the concave upper surface of the actuation part 10 over a larger area, it can provide improved adhesion between the finger and the actuation part 10.

Furthermore, by setting the slope angles of each region of the actuation part 10 based on the curvature of the thumb, a more ergonomic contact can be provided.

Referring to FIGS. 5 and 6, an elastic part 120 may be positioned on the upper surface of the actuation part 10, and the elastic part 120 may include a first elastic part 122 and a second elastic part 124.

When the elastic part 120 is positioned on the upper surface of the actuation part 10, the user's finger contacts the elastic part 120 when operating the actuation part 10. Therefore, the elastic part 120 can increase the frictional force generated between the user's finger and the upper surface of the actuation part 10 during operation. As the frictional force generated between the user's finger and the upper surface of the actuation part 10 increases, the user can apply less force to the actuation part 10 during operation.

Referring to FIG. 5, the elastic part 120 may be concentrically arranged on the central portion 110, the first region 112, the second region 114, the third region 116, and the fourth region 118 of the upper surface of the actuation part 10. However, the arrangement is not necessarily limited to this.

The center of the concentrically arranged elastic part 120 may be the center of the central portion 110. With the elastic part 120 arranged concentrically around the center of the central portion 110, the user can operate the actuation part 10 more stably.

Additionally, the elastic part 120 may be formed only on a portion of the upper surface of the actuation part 10. For example, it may be formed only on the first region 112 and the second region 114. Since the actuation part 10 mainly moves forward and backward, having the elastic part 120 formed only on the first region 112 and the second region 114 can still be useful for operating the actuation part 10.

According to an embodiment of the present disclosure, the elastic part 120 has the same shape as the edge of the upper surface of the actuation part 10 and is arranged concentrically, but its shape is not limited to this.

Specifically, the elastic part 120 may include a first elastic part 122 positioned on at least a portion of the central portion 110 without shape limitation, and a second elastic part 124 surrounding the first elastic part 122. The first elastic part 122 is preferably positioned at the center of the central portion 110 but is not necessarily limited to this.

Additionally, the second elastic part 124, having concentric rings, can provide stable contact force.

If it is possible to increase friction between the user's finger and the upper surface of the actuation part 10 when the user's finger contacts the upper surface of the actuation part 10, the size, arrangement, and number of the first elastic part 122 and the second elastic part 124 are not limited to the embodiments of the present disclosure.

Meanwhile, the first elastic part 122 and the second elastic part 124 may be composed of elastic members with different elastic coefficients or elastic members with the same elastic coefficient.

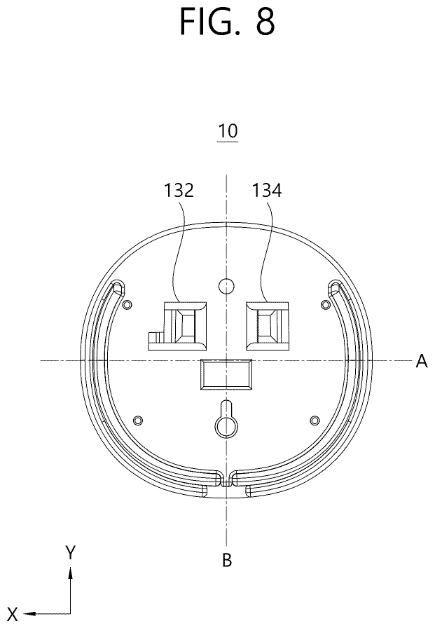

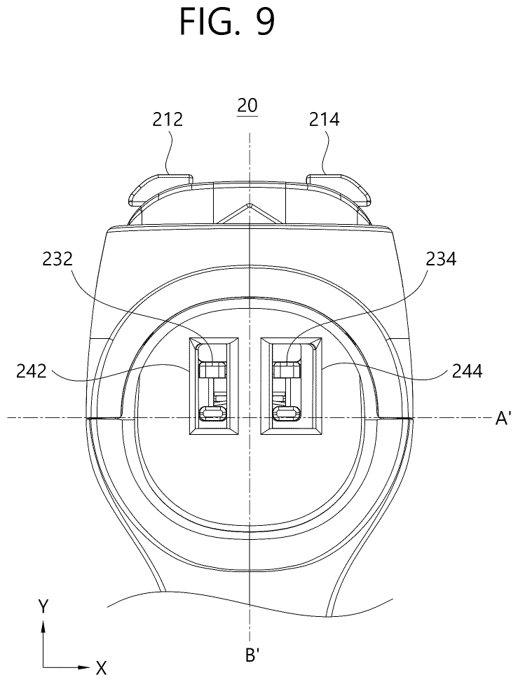

FIG. 8 is a bottom view of the actuation part according to an embodiment of the present disclosure, and FIG. 9 is a top view of the head part according to an embodiment of the present disclosure.

Referring to FIGS. 4 and 6 to 8, the actuation part 10 may include a first protrusion 132 and a second protrusion 134, each extending downward. Also, referring to FIG. 9, the top surface of the head part 20 may include the first accommodating part 242 and the second accommodating part 244, each corresponding to the first protrusion 132 and the second protrusion 134, respectively.

The first protrusion 132 may be received in the first accommodating part 242, and the second protrusion 134 may be received in the second accommodating part 244. Each of the first protrusion 132 and the second protrusion 134 is received in the first accommodating part 242 and the second accommodating part 244, respectively, allowing the actuation part 10 and the head part 20 to be coupled.

Referring to FIG. 4, the first protrusion 132 and the second protrusion 134 may be inserted into the holes 232 and 234 after passing through the accommodating parts 242 and 244, respectively.

Referring to FIGS. 8 and 9, while the actuation part 10 includes the first protrusion 132 and the second protrusion 134, and the head part 20 includes the first accommodating part 242 and the second accommodating part 244, this is not necessarily limiting.

In other words, the actuation part 10 may include the first accommodating part 242 and the second accommodating part 244, and the head part 20 may include the first protrusion 132 and the second protrusion 134. In this case, each of the first protrusion 132 and the second protrusion 134 can be received in the first accommodating part 242 and the second accommodating part 244, respectively, allowing the actuation part 10 and the head part 20 to be coupled.

According to one embodiment of the present disclosure, while there are two protrusions 132 and 134 and two accommodating parts 242 and 244, the number of each is not necessarily limited as long as the actuation part 10 and the head part 20 can be coupled with the protrusions 132 and 134 received in the accommodating parts 242 and 244.

Referring to FIG. 7, the first protrusion 132 and the second protrusion 134 may be spaced apart in the transverse direction on the bottom surface of the actuation part 10. Specifically, the first protrusion 132 may be located under the third region 116, and the second protrusion 134 may be located under the fourth region 118.

Additionally, referring to FIG. 9, the first accommodating part 242 and the second accommodating part 244 may be spaced apart in the transverse direction on the top surface of the head part 20 and positioned corresponding to the first protrusion 132 and the second protrusion 134.

Referring to FIGS. 7 and 8, the first protrusion 132 and the second protrusion 134 may have different shapes. Due to the different shapes of the first protrusion 132 and the second protrusion 134, the actuation part 10 can be assembled to the head part 20 in only one direction during the assembly of the razor handle 1.

In one embodiment of the present disclosure, the second protrusion 134 additionally includes a portion extending transversely on its upper portion from the symmetrical shape of the first protrusion 132 about the B-axis. That is, the maximum transverse length of the second protrusion 134 can be greater than the maximum transverse length of the first protrusion 132.

Therefore, referring to FIG. 4, the shapes of the first accommodating part 242 and the second accommodating part 244 may differ according to the shapes of the first protrusion 132 and the second protrusion 134.

Meanwhile, since the shapes of the first protrusion 132 and the second protrusion 134 are different, the actuation part 10 can be coupled to the head part 20 in only one specific direction.

That is, considering the ergonomic shape and functionality of the upper surface of the actuation part 10, the actuation part 10 should be assembled to the head part 20 such that the first region 112 is positioned forward and the second region 114 is positioned backward. Thus, the first protrusion 132 and the second protrusion 134 are designed to guide this assembly direction. Consequently, it is not possible to assemble the actuation part 10 to the head part 20 with the first region 112 positioned backward and the second region 114 positioned forward.

Therefore, the actuation part 10 can be assembled to the head part 20 with a direction restricted such that the slope angle of the region positioned forward of the central portion 110 is not smaller than the slope angle of the region positioned rearward of the central portion 110.

Meanwhile, if the structure can limit the installation direction of the actuation part 10 so that it is installed on the head part 20 in only one direction, the shapes of the first protrusion 132 and the second protrusion 134 can be identical.

For example, even if the shapes of the first protrusion 132 and the second protrusion 134 are the same, if the first protrusion 132 and the second protrusion 134 are each positioned asymmetrically with respect to the A-axis in FIG. 8, the actuation part 10 can only be coupled to the head part 20 in one direction. The A-axis is a transverse axis passing through the central portion 110 of the actuation part 10.

In other words, if the distance between the first protrusion 132 and the A-axis differs from the distance between the second protrusion 134 and the A-axis, the actuation part 10 can only be coupled to the head part 20 in one direction.

Additionally, if both the first protrusion 132 and the second protrusion 134 are located on one side of the A-axis, the actuation part 10 can only be coupled to the head part 20 in one direction. As another example, even if the shapes of the first protrusion 132 and the second protrusion 134 are the same, if the first protrusion 132 and the second protrusion 134 are each positioned asymmetrically with respect to the B-axis in FIG. 8, the actuation part 10 can only be coupled to the head part 20 in one direction. The B-axis is a longitudinal axis passing through the central portion 110 of the actuation part 10.

In other words, if the distance between the first protrusion 132 and the B-axis differs from the distance between the second protrusion 134 and the B-axis, the actuation part 10 can only be coupled to the head part 20 in one direction.

Additionally, if both the first protrusion 132 and the second protrusion 134 are located on one side of the B-axis, the actuation part 10 can only be coupled to the head part 20 in one direction.

Meanwhile, since the first accommodating part 242 and the second accommodating part 244 correspond to the first protrusion 132 and the second protrusion 134, respectively, if the shapes of the first protrusion 132 and the second protrusion 134 are the same, the shapes of the first accommodating part 242 and the second accommodating part 244 can also be the same.

However, similar to the first protrusion 132 and the second protrusion 134, the first accommodating part 242 and the second accommodating part 244 can be arranged asymmetrically with respect to the A′ axis or arranged with respect to the B′ axis to ensure that the actuation part can only be coupled to the head part in one direction.

Referring to FIG. 9, the first accommodating part 242 and the second accommodating part 244 are formed to extend in the front-rear direction. Therefore, with the first protrusion 132 and the second protrusion 134 received in the first accommodating part 242 and the second accommodating part 244, respectively, the actuation part 10 can move forward and backward.

Specifically, the first accommodating part 242 and the second accommodating part 244 can be formed to extend in the front-rear direction such that the actuation part 10 can move forward by a distance between 1.5 mm and 3.5 mm from the neutral position and can move backward by a distance between 0.5 mm and 2.5 mm from the neutral position.

Preferably, the first accommodating part 242 and the second accommodating part 244 can be formed to extend in the front-rear direction such that the actuation part 10 can move forward by a distance between 2.0 mm and 3.0 mm from the neutral position and can move backward by a distance between 1.0 mm and 2.0 mm from the neutral position.

In another embodiment of the present disclosure, the head part 20 may not include the head adapter 24 and the restoring force providing part 25. In this case, the first hole 232 and the second hole 234 have positions and shapes corresponding to the first protrusion and the second protrusion, and can perform the same function as the first accommodating part 242 and the second accommodating part 244, respectively.

In this case, even if the head part 20 does not include the head adapter 24 and the restoring force providing part 25, the shape of the upper surface of the actuation part 10 corresponding to the curvature of the user's thumb prevents the thumb from slipping off the actuation part 10, and the actuation part 10 can have slopes on the front and rear surfaces to allow the actuation part 10 to be operated with minimal force.

In another embodiment of the present disclosure, the accommodating parts 242 and 244 may be formed on the actuation part 10, and the protrusions 132 and 134 may be formed on the head part 20. That is, according to the present disclosure, the protrusions 132 and 134 may be formed on either the actuation part 10 or the head part 20, and the accommodating parts 242 and 244 may be formed on the other part.

Thus, the razor handle 1 according to the present disclosure allows the user to easily remove the razor cartridge 2 from the razor handle 1.

Additionally, the razor handle 1 according to the present disclosure increases the contact area between the user's finger and the upper surface of the actuation part 10, reducing the pressure required to operate the actuation part 10, and increases the friction between the user's finger and the upper surface of the actuation part 10, reducing the force required to operate the actuation part 10.

Furthermore, the razor handle 1 according to the present disclosure prevents incorrect assembly of the actuation part 10 and the head part 20 by asymmetrically forming or positioning the first protrusion 132 and the second protrusion 134.

It will be understood by those skilled in the art to which the present disclosure pertains that the present disclosure can be implemented in other specific forms without changing its technical spirit or essential characteristics. Therefore, the embodiments described above should be understood as illustrative in all respects and not restrictive. The scope of the present disclosure is indicated by the following claims rather than the foregoing detailed description, and all changes or modifications derived from the meaning, scope, and equivalent concept of the claims should be interpreted as being included in the scope of the present disclosure.

What is claimed is:

1. A razor handle configured to couple with a razor cartridge that accommodates at least one blade, the razor handle comprising:
a head part detachably coupled to the razor cartridge and extending at least partially in the longitudinal direction;
a grip part extending rearward from the head part; and
an actuation part provided in the head part, configured to operate the release of the razor cartridge in response to the head part and the razor cartridge being coupled,
wherein the upper surface of the actuation part comprises:
a central portion,
a first region sloping upward from the central portion toward the front,
a second region sloping upward from the central portion toward the rear,
a third region sloping upward from the central portion toward one lateral side in a transverse direction perpendicular to the longitudinal direction, and
a fourth region sloping upward from the central portion toward the other lateral side in the transverse direction.

2. The razor handle of claim 1, wherein a first slope angle of the first region is greater than a second slope angle of the second region, and
wherein the actuation part is configured to move forward from a neutral position to release the razor cartridge.

3. The razor handle of claim 1, wherein the first slope angle of the first region and the second slope angle of the second region are the same, and
wherein the actuation part moves forward from a neutral position to release the razor cartridge.

4. The razor handle of claim 2, wherein the actuation part is movable forward and backward along the longitudinal direction from the neutral position.

5. The razor handle of claim 4, wherein the forward movement distance of the actuation part from the neutral position is longer than the backward movement distance from the neutral position.

6. The razor handle of claim 2, wherein the first slope angle is between 30 degrees and 65 degrees.

7. The razor handle of claim 2, wherein the second slope angle is between 10 degrees and 40 degrees.

8. The razor handle of claim 1, wherein one of the actuation part and the head part includes a first protrusion and a second protrusion, and the other includes a first accommodating part capable of receiving the first protrusion and a second accommodating part capable of receiving the second protrusion, and
wherein the first protrusion is located below the third region, and the second protrusion is located below the fourth region.

9. The razor handle of claim 8, wherein the shape of the first protrusion and the shape of the second protrusion are different.

10. The razor handle of claim 8, wherein the first protrusion and the second protrusion are asymmetrically formed with respect to a longitudinal axis passing through the central portion.

11. The razor handle of claim 8, wherein the first protrusion and the second protrusion are asymmetrically formed with respect to a transverse axis passing through the central portion.

12. The razor handle of claim 8, wherein the first accommodating part and the second accommodating part extend forward or backward to allow the first protrusion and the second protrusion to move forward or backward, and
wherein the actuation part is movable forward by a distance between 1.5 mm and 3.5 mm from a neutral position and backward by a distance between 0.5 mm and 2.5 mm from the neutral position.

13. A razor handle configured to couple with a razor cartridge that accommodates at least one blade, the razor handle comprising:
a head part detachably coupled to the razor cartridge and extending at least
partially in the longitudinal direction;
a grip part extending rearward from the head part; and
an actuation part provided in the head part, configured to operate the release of the razor cartridge when the head part and the razor cartridge are coupled,
wherein the upper surface of the actuation part comprises:
a central portion,
a first region inclined upward from the central portion at a first slope angle toward the front, and
a second region inclined upward from the central portion at a second slope angle toward the rear, and
wherein the first slope angle is greater than the second slope angle.

14. The razor handle of claim 13, wherein one of the actuation part and the head part includes a first protrusion and a second protrusion, and the other includes a first accommodating part capable of receiving the first protrusion and a second accommodating part capable of receiving the second protrusion, and
wherein the first protrusion and the second protrusion are spaced apart in the transverse direction perpendicular to the longitudinal direction.

15. The razor handle of claim 14, wherein the shape of the first protrusion and the shape of the second protrusion are different.

16. The razor handle of claim 14, wherein the first protrusion and the second protrusion are asymmetrically formed with respect to a longitudinal axis passing through the central portion.

17. The razor handle of claim 14, wherein the first protrusion and the second protrusion are asymmetrically formed with respect to a transverse axis passing through the central portion.

18. The razor handle of claim 13, wherein the actuation part is movable forward and backward along the longitudinal direction.

19. The razor handle of claim 13, wherein the central portion includes a partially flat area.

20. The razor handle of claim 13, wherein the first slope angle is between 30 degrees and 65 degrees, and
wherein the second slope angle is between 10 degrees and 40 degrees.
